(19) United States
(12) Patent Application Publication
(10) Pub. No.: US 2004/0000200 A1
(43) Pub. Date: Jan. 1, 2004

(54) Purge system and method for accelerating environmental stress tests

(75) Inventors: Michael David Ries, Broomfield, CO (US); Jeffrey Leonard Bruce, Longmont, CO (US); Robert Allen Bruce, Longmont, CO (US); Aaron Monroe Payne, Denver, CO (US); Rory Stephen Goodman, Boulder, CO (US); Carl Douglas Hutchings, Longmont, CO (US); Matthew Jason Gosch, Boulder, CO (US)

Correspondence Address: Merchant & Gould P.C., P.O. Box 2903, Minneapolis, MN, 55402-0903, US

(73) Assignee: Seagate Technology LLC

(21) Appl. No.: 10/183,094

(22) Filed: Jun. 26, 2002

(51) Int. Cl. G01N 1/14

(52) U.S. Cl. 73/864.34

(57) ABSTRACT

A method of actively transporting atmosphere, including gases and other fluids, to and from an inner compartment of a sealed system. The purged atmosphere is replaced with another atmosphere having target characteristics. A vacuum purge system pulls atmosphere from the sealed system, while a pressure-based system pushes atmosphere into the sealed system. Humidity corrosion tests are accelerated over prior methods because purged atmosphere is actively transported out of the sealed system and characteristic atmosphere is actively transported into the sealed system.

### FILED OF THE INVENTION

This application relates generally to environmentally testing a sealed system. More particularly, the application relates to actively transporting atmosphere having target criteria into an internal compartment of the sealed system to rapidly expose the internal compartment to the target atmosphere.

### BACKGROUND OF THE INVENTION

Many electronic devices, such as disc drives, undergo performance tests. One type of performance test is an environmental test, wherein a device, including the device's internal components, is tested under predetermined environmental conditions. Environmental testing of these devices can occur at any point in the development process of the electronic device. Frequently testing occurs after a design stage and before a large-scale manufacturing stage to test the design of the device. Environmental testing may also occur as an ongoing quality assurance effort after large-scale manufacture begins. Regardless of where in the development process environmental testing occurs, makers of these devices are typically strongly motivated to reduce “time-to-market”; i.e., the time required from initial design to actual sales in the market. Additionally, in order for environmental tests to be of most value, the testing should be controllable and deliver consistent results.

Many electronic devices are sealed or substantially sealed so that internal components of the electronic device are protected from potentially destructive elements. The sealed nature of many electronic devices, and disc drives in particular, often makes environmental testing difficult, uncontrollable, and time-consuming. Prior approaches to environmental testing of sealed devices incur a substantial time requirement that significantly increases the time-to-market beyond the time-to-market without such testing. The substantial time requirement is largely due to the sealed nature of many electronic devices.

For example, in the disc drive industry, in order to test corrosive effects of humidity on internal components of a disc drive, the disc drive is placed in an environmental chamber and left in the chamber until the atmosphere in the internal compartment of the disc drive meets predetermined criteria. The environmental chamber modifies the atmosphere surrounding the disc drive in the chamber to meet a predetermined relative humidity. The disc drive cannot be tested until the internal compartment of the disc drive reaches the test relative humidity, to ensure that the inner components have been exposed to the humidity. Because disc drives are substantially sealed to protect the internal components, for some models of disc drives it takes several days to weeks for the inner compartment of the disc drive to reach the predetermined humidity level required for testing.

Another problem is related to variability in designed-in diffusion paths. For example, some disc drives have a designed-in breather hole to allow equilibration of pressure between their interior and exterior environments. These breathers may include diffusion-limiting features. Manufacturing processes of the breather holes and their associated features create variability in their dimensions, creating variability in diffusion rates. Thus, using passive approaches to reach equilibration in disc drives having breather holes and diffusion features with wide variability lead to environmental test results with wide variability. The wide variability of results obtained using designed-in diffusion paths can make results interpretation, comparison, and decision-making difficult.

A related problem is inconsistency of environmental test results. Because diffusion paths and their associated diffusion rates are largely random and variable as discussed above, test results are often inconsistent from device to device due to dissimilarity in exposure experienced by internal components. For example, one disc drive may have a higher diffusion rate, and thus have internal components more exposed to humidity than another disc drive that has a lower diffusion rate and thus less internal exposure to humidity. Differences in test results in the example most likely indicate a difference in diffusion rate, and not the ability of internal components to operate after exposure to humidity. The range of diffusion rates across different device designs or models is typically much greater than within a particular device design. Thus, inconsistencies in environmental test results are particularly pronounced when devices are from a different design or model.

Accordingly there is a need for a system and method of controlling and/or accelerating environmental testing of substantially sealed devices.

### SUMMARY OF THE INVENTION

Embodiments of the present invention accelerate environmental testing of substantially sealed devices by creating a direct connection between a target environment and the inner compartment of the device. A port in a casing of the device allows for direct communication of a target environment to the inner compartment. Embodiments include a pressurization mechanism for pulling or pushing target atmosphere into the inner compartment, thereby accelerating equilibration of the inner compartment with the target atmosphere. In a particular embodiment, a substantially sealed device is placed in an environmental chamber, a pump is attached to a port in the casing of the device, and the pump is activated to pull a target atmosphere from the environmental chamber into the inner compartment of the device through a flow path, such as a breather hole.

An embodiment of the present invention may be viewed as a method of environmentally testing a substantially sealed device by actively transporting atmosphere from a test environment into an internal compartment of the substantially sealed device. Actively transporting atmosphere may involve connecting a proximate end of an atmosphere transport connector to a port in a housing of the device and activating a pressurization mechanism to actively transport atmosphere out of the internal compartment via the atmosphere transport connector, and to actively transport the atmosphere from the test environment into the internal compartment of the device via a flow path in the housing.

The method may further include placing the device in an environmental chamber having a target atmosphere meeting target criteria, and establishing the test environment in the environmental chamber. The method may further include connecting a pump to a distal end of the atmosphere transport connector, and activating the pump to pull atmosphere from the internal compartment of the substantially sealed device.

Another embodiment may be viewed as an environmental test system for performing environmental tests on a device having a housing that forms a substantially sealed internal compartment, wherein the housing has a flow path allowing atmosphere to flow there through. The environmental test system includes a port module attached to an opening in the housing. In a particular embodiment, the port module is attached to an atmosphere transport connector to transport atmosphere to or from the internal compartment, and/or a pressurization mechanism in fluid communication with the internal compartment of the device and the atmosphere transport connector.

One embodiment of the environmental test system includes a pump attached to a distal end of the atmosphere transport connector, whereby the pump can pull atmosphere out of the internal compartment. In another embodiment, spinning discs in a disc drive serve as the pressurization mechanism. In yet another embodiment, a controlled flow path module is included to create a desired flow rate in the device for simulating diffusion through the housing of the device.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive having a substantially sealed casing forming an inner compartment, which may be environmentally tested using an embodiment of the present invention.

FIG. 2 is a perspective cutaway view of an environmental chamber having a target environment and a disc drive immersed therein in accordance with an embodiment of the present invention.

FIG. 3 is a side-on sectional view of a disc drive in an environmental chamber in accordance with an embodiment of the present invention.

FIG. 4 is a side-on sectional view of a disc drive in an environmental chamber having a controlled diffusion mechanism, a humidity sensor, and a valve in accordance with an embodiment of the present invention.

FIG. 5 is a perspective view of a manifold that may be used to connect multiple devices to a pump for environmental testing in accordance with an embodiment of the present invention.

FIG. 6 is a graph illustrating a response to application of a target environment in accordance with an embodiment of the present invention.

FIG. 7 is an operation flow diagram illustrating exemplary operations performed in accordance with an embodiment of the present invention.

### DETAILED DESCRIPTION

Exemplary embodiments of the present invention are described herein with reference to a series of figures. An embodiment of the present invention may be viewed as a method or system for performing an environmental test upon a substantially sealed device having a casing, housing components in an internal compartment. More particularly, an embodiment includes a method or system for actively transporting atmosphere into the internal compartment of the device. More particularly still, an embodiment includes forming a port in the casing, coupling a pressurization mechanism to the port, and activating the pressurization mechanism to actively transport atmosphere meeting target environmental criteria into or out of the internal compartment of the device. The method may further include closing the port. As a result of active transport of atmosphere, atmosphere in the internal compartment equilibrates quickly with respect to atmosphere outside the casing of the device.

Embodiments of the testing system and method are described herein in an exemplary context of environmentally testing a disc drive. A disc drive is one particular type of substantially sealed device having a casing that houses components in an internal compartment. The components in the internal compartment may be electronic or otherwise, and typically exhibit a response to elements that enter the internal compartment. By way of example, and not limitation, humidity in the atmosphere in the internal compartment can cause a corrosive effect upon the components, and may cause the components to behave differently than a standard behavior. It is to be understood that other types of substantially sealed devices that have internal compartments may be tested using embodiments of the present invention, and that a disc drive is merely one example of one such device that may undergo testing. It is also to be understood that environmental testing using systems and methods described herein, may involve use of test atmosphere having any relevant testing parameters, and humidity is merely one example of one such testing parameter.

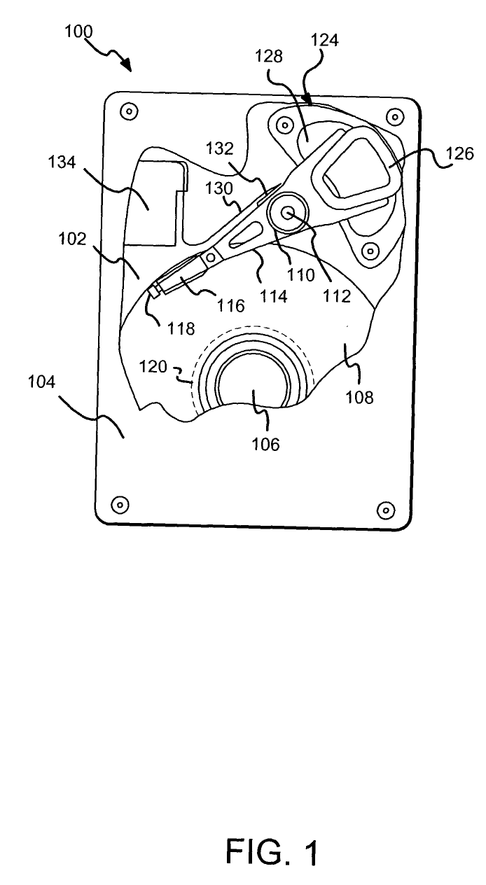

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, substantially sealed environment or compartment for the disc drive in a conventional manner. The top cover 104, together with the base 102, forms a casing or housing that contains the components in the internal compartment. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base 102 to a disc drive printed circuit board (not shown) mounted to the bottom side of the disc drive 100.

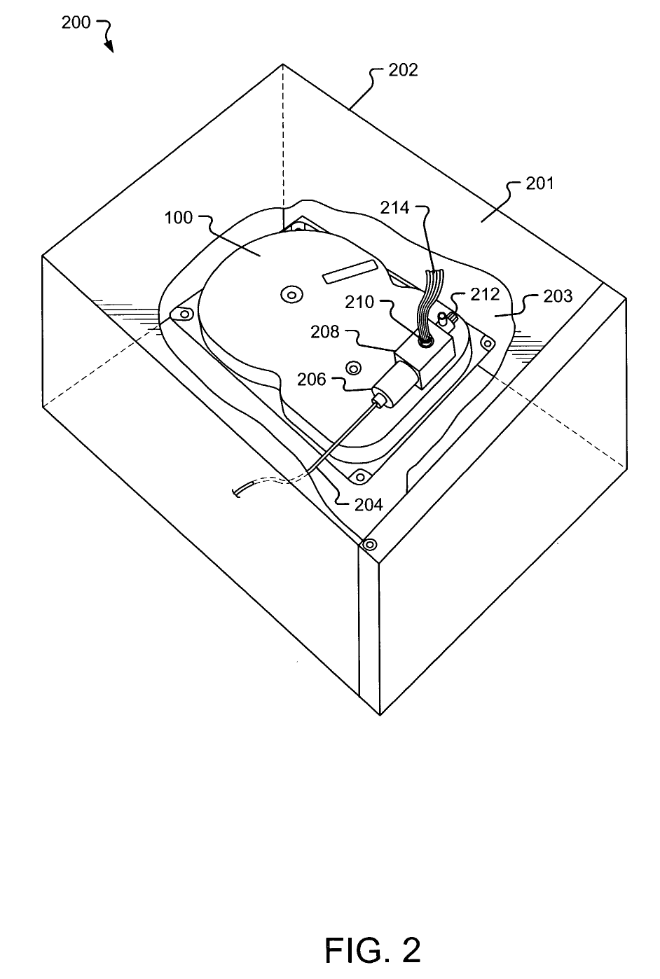

A perspective view of an environmental test system 200 is illustrated in FIG. 2. The environmental test system includes an environmental chamber 202. A top cover 201 of the chamber 202 is partially cut away to expose an internal cavity 203, wherein a substantially sealed device, such as the disc drive 100, is positioned. The cavity 203 of the environmental chamber 202 contains an atmosphere that substantially surrounds the disc drive 100. The atmosphere is composed of any number of gases. The atmospheric gases generally refer to fluids in the gaseous state having neither independent shape nor volume and being able to expand indefinitely. A fluid refers generally to a continuous amorphous substance that tends to flow and to conform to the outline of its container, such as the environmental chamber 202. By way of example, and not limitation, a gas includes an aerosol composition, which includes particles in a non-gaseous phase that are suspended in the gas.

The atmosphere in the cavity 203 of the environmental chamber 202 is characterized by certain parameters, such as, but not limited to, a relative humidity, a temperature, aerosol composition, concentration of gases other than air, and density. The environmental chamber 202 is operable to modify one or more parameters of the atmosphere to reach predetermined target values. In one embodiment, the environmental chamber 202 is operable to adjust the temperature of the atmosphere in the cavity 203 to reach a predetermined target temperature. In another embodiment, the environmental chamber 202 is operable to adjust the relative humidity of the atmosphere in the cavity 203 to reach a predetermined target relative humidity. In yet another embodiment, the environmental chamber 202 is operable to maintain a target relative pressure within the cavity 203. The target values for the atmosphere are typically chosen in accordance with environmental tests, which the disc drive 100 is to undergo.

The environmental tests may be designed to test component behavior under anticipated operational conditions of the disc drive 100. Alternatively, the environmental tests may test the disc drive 100 under stressed (non-operational) conditions. For example, an environmental test under operational conditions may include testing the disc drive 100 in atmosphere having a target relative humidity of 20%. An example of a stress test is one that tests the disc drive 100 in 80% relative humidity. The environmental chamber 202 is able to adjust the characteristics of the atmosphere that surrounds the disc drive 100 to meet target characteristics, but because of the substantially sealed nature of the disc drive 100, the environmental chamber 202 may not be able to directly change the target characteristics of the atmosphere in the internal compartment of the disc drive 100.

In the particular embodiment illustrated in FIG. 2, a proximate end of a connector 204 is coupled to a port (not shown) in the casing of the disc drive 100. The connector 204 is connected to a valve 206, which can be opened and closed to start or stop air flow between the connector 204 and the disc drive 100, respectively. The valve 206 is attached to a port module 208, which includes a sensor connector 210 and a diffusion controller 212. The port module 208 is affixed to the port (not shown) in the disc drive 100 casing to thereby hold the port 208, the valve 206, and the connector 204 in position to facilitate active transportation of atmosphere from the cavity 203 into the inner compartment of the disc drive 100.

In one embodiment, a distal end of the connector 204 extrudes outside a wall of the chamber 202 and connects to a pressurization mechanism, such as a pump. Via the connector 204, fluid communication is established between the internal compartment of the disc drive 100 and the pump. When the pump is turned on, atmosphere is pulled out of the internal compartment of the disc drive 100. In response, atmosphere in the cavity 203 is pulled into the internal compartment of the disc drive 100. Thus, the internal compartment and components housed therein are rapidly exposed to the target environment created in the chamber 202.

In one embodiment, the sensor connector 210 is coupled to a humidity detector in the port module 208. The humidity detector (not shown) detects humidity in the atmosphere of the internal compartment of the disc drive 100 and/or atmosphere flowing between the internal compartment and the connector 204. A signal path 214 carries signals from the humidity detector. The signals from the humidity detector may be used for any number of purposes, including but not limited to, closing the valve 206, turning off a pump, and/or any relevant analysis. The signal paths 214 include any communication mechanism, such as electrical wiring, or a wireless communication path.

The connector 204 and the signal paths 214 extrude beyond walls of the environmental chamber 202 in a particular embodiment of the environmental testing system 200. For example, the connector 204 in a preferred embodiment is connected to a pressurization mechanism, such as a pump, for pulling atmosphere out of the internal compartment of the disc drive 100. While the pump pulls atmosphere out of the internal compartment of the disc drive 100, a pressure is created that pulls atmosphere from the cavity 203 of the environmental chamber 202 into the internal compartment of the disc drive 100. Points at which the connector 204 and the signal paths 214 leave the surface of the environmental chamber 202, preferably include a sealing mechanism, such as a gasket, and/or o-ring, to prevent leaks in the system 200. In one embodiment, the valve 206 is a solenoid valve powered by an electrical signal. In an alternative embodiment, the valve 206 is powered in a pneumatic fashion by atmosphere being pulled through the valve.

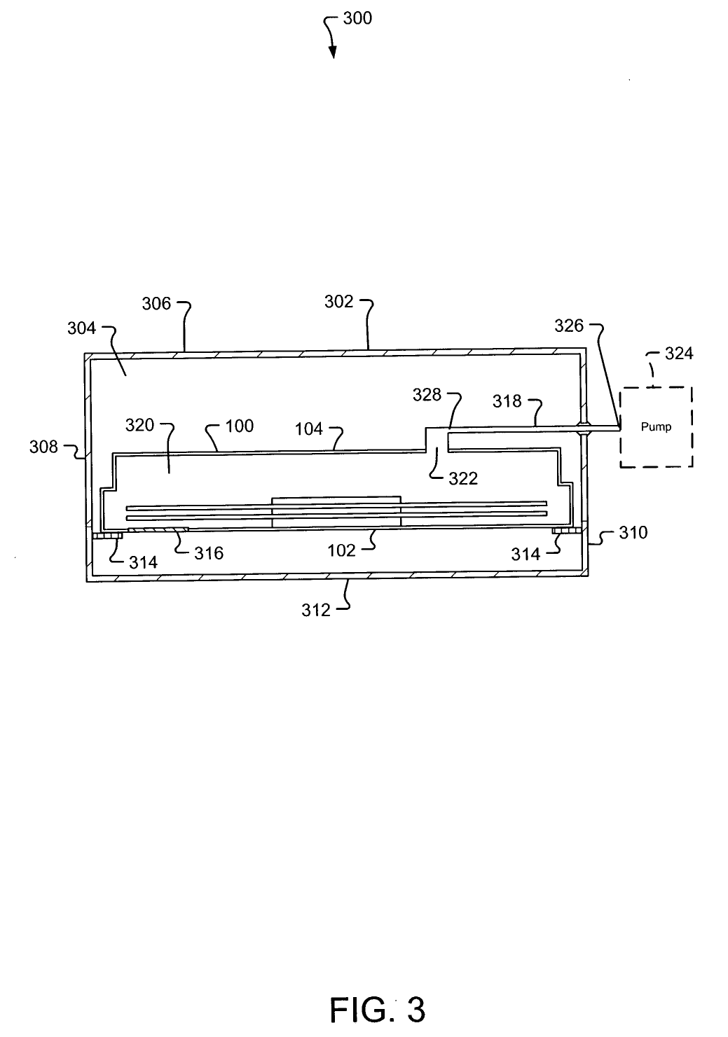

FIG. 3 is a side-on sectional view 300 of a disc drive 100 in an environmental chamber 302 in accordance with an embodiment of the present invention. The disc drive 100 is positioned in a cavity 304 of the chamber 302. The cavity 304 contains atmosphere meeting target criteria, such as, but not limited to, target humidity, temperature or gaseous contaminant. The chamber 302 includes a top wall 306, a first side wall 308, a second side wall 310, and a bottom wall 312. Together the walls 306, 308, 310, and 312, create the cavity 304.

In the particular embodiment shown in FIG. 3, the disc drive 100 rests on risers, such as shelves 314, such that the disc drive 100 is substantially surrounded by atmosphere in the cavity 304, including the bottom surface of the disc drive 100. The risers raise the disc drive 100 off the bottom wall 312 of the environmental chamber 302. Examples of other types of risers are raised platforms or shelves with aerated slots that allow the cavity atmosphere to contact the base 102 of the disc drive 100. The disc drive 100 includes a flow path, such as a breather hole 316. The breather hole 316 may be used for pressure equilibration and out-gassing undesirable gasses that often form during disc drive operation. In many disc drive designs, the breather hole 316 includes a filter and/or an absorbent material for filtering out undesirable contaminants that may harm the components in the disc drive 100. In the disc drive industry the breather hole 316 may also include a diffusion-limiting feature, such as a labyrinth. Embodiments of the present invention overcome the filtering or absorbent nature of the breather hole for testing purposes. Via the breather hole 316, atmosphere can be pulled into the inner compartment 320 to facilitate analysis of the response exhibited by components in the disc drive 100.

In a particular embodiment, a connector 318 connects the disc drive 100 to a pressurization mechanism, such as a pump 324, in order to pull atmosphere from the cavity 304 into the inner compartment 320 of the disc drive 100 via the breather hole 316. The connector 318 is connected to a port 322 on the top cover 104 of the disc drive 100. The connector 318 may be attached by any means as may be known in the art, including, but not limited to, a threaded coupling, or a glue mount. The connection between the port 322 and the connector 318 is preferably sealed to prevent leakage. A pump 324 connected to the connector 318 creates a pressure or suction that pulls atmosphere out of the inner compartment 320 of the disc drive 100, which in turn pulls atmosphere from the cavity 304 into the inner compartment 320 of the disc drive 100. Consequently, by using the pump 324 or other pressurization mechanism, atmosphere is actively transported from the chamber cavity 304 into the internal compartment 320 of the disc drive 100.

By actively transporting atmosphere from the cavity 304 into the internal compartment 320 of the disc drive 100, the atmosphere in the internal compartment 320 equilibrates quickly with the atmosphere in the cavity 304. By rapidly equilibrating the atmosphere in the internal compartment 320 with the atmosphere in the cavity 304, environmental testing can be greatly expedited over prior approaches that do not use active atmosphere transport. In addition, and in contrast to prior approaches, the process of filling the internal compartment 320 with target atmosphere is controllable. For example, the pump 324 connected to the disc drive 100 may be turned on or off at controlled times, or the pressure applied by the pump 324 may be controlled.

In another embodiment, atmospheric pressure in the cavity 304 of the environmental chamber 302 is elevated with respect to the atmospheric pressure in the internal compartment 320 of the disc drive 100 to facilitate more rapid equilibration. In this embodiment, atmospheric flow generated by the pump 324 is increased due to the pressure differential. The pressure differential between the atmosphere in the cavity 304 and the compartment 320 essentially pushes the atmosphere from the cavity 304 into the internal compartment 320 via the breather hole 316. Examples of chambers that may be used in this elevated pressure embodiment are an elevated pressure chamber and an autoclave, among others.

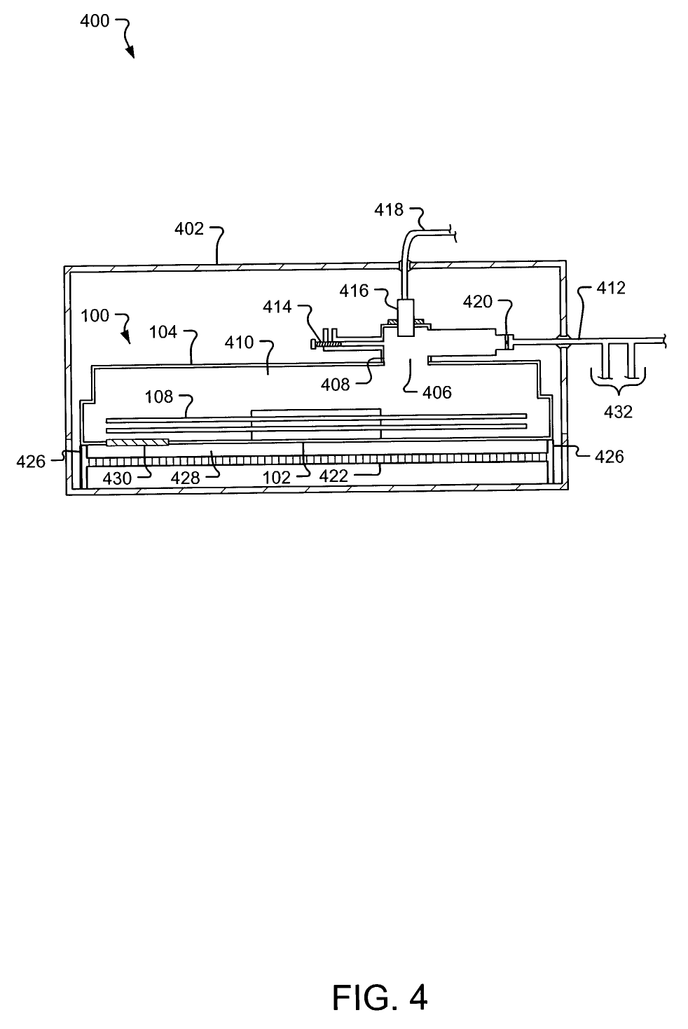

FIG. 4 is a side-on sectional view 400 of a disc drive 100 in an environmental chamber 402 in accordance with another embodiment of the present invention. In this particular embodiment, the top surface 104 of the disc drive 100 includes a port 406 attached to a port module 408 that couples the internal compartment 410 of the disc drive 100 to an external connector 412. Via the port 406, the port module 408, and the external connector 412, atmosphere can flow from the internal compartment 410 out of the disc drive 100.

In a particular embodiment, the port module 408 has a controlled diffusion mechanism 414, and a sensor 416 attached thereto. The controlled diffusion mechanism 414 is adjustable during testing to simulate an airflow path in the housing of the disc drive 100. The sensor 416 is immersed in atmosphere from the internal compartment 410 and detects a predetermined atmospheric condition relevant to environmental testing. One embodiment of the sensor 416 is a humidity sensor that detects the level of relative humidity in the atmosphere of the internal compartment 410 of the disc drive 100. Sensor signals from the sensor 416 are carried by signal paths 418, and may be used during testing for a variety of purposes, examples of which are discussed below in detail. The particular placement of the port module 408, controlled diffusion mechanism 414, and the sensor 416 may be changed for any particular implementation without straying from the scope of the present invention.

In another particular embodiment, the port module 408 has a valve 420 that couples the external connector 412 to the port module 408. The valve 420 may be opened and closed to control airflow to and from the internal compartment 410 of the disc drive 100. The valve 420 may be opened and closed electronically, manually, or pneumatically, or by any other mechanism as may be known in the art. One embodiment of the valve 420 is a solenoid valve. It is to be understood that FIG. 4 illustrates the controlled diffusion mechanism 414, the sensor 416, and the valve 420 in a particular embodiment of an environmental test system. Other embodiments may not have the controlled diffusion mechanism 414, the sensor 416, or the valve 420 or may have one or more of these features in any combination.

As illustrated, the disc drive 100 rests on a riser, such as a platform 422, such that atmosphere in the environmental chamber 402 substantially surrounds the bottom surface 102 of the disc drive 100. In the particular embodiment shown in FIG. 4, the platform 422 has stand-offs 426 to create a void 428 between the bottom surface 102 and the platform 422. Other types of risers as are known in the art may be used in any particular implementation.

The disc drive 100 includes a flow path in the casing of the disc drive, such as a breather hole 430 in the bottom surface 102. As discussed above, the breather hole 430 may contain a filter or absorbent material. The breather hole 430 allows atmosphere to flow in and out of the internal compartment 410 of the disc drive 100. In a particular embodiment, the atmosphere in the environmental chamber 402 is pulled through the breather hole 430 and into the internal compartment 410 of the disc drive 100. For example, atmosphere in the cavity of the chamber 402 can be pulled through the breather hole 430 into the internal compartment 410 by opening the valve 420 and spinning one or more discs 108 in the disc drive 100. When the discs 108 spin, the target atmosphere is pulled into the internal compartment 410 via the breather hole 430, and atmosphere is actively transported out of the internal compartment 410 via the atmosphere transport connector 412.

In an alternative embodiment, a pressurization mechanism, such as a pump (not shown), is connected to the atmosphere transport connector 412. In this embodiment, the pump pulls atmosphere from the internal compartment 410 when the valve 420 is opened. In response to pulling atmosphere from the internal compartment 410, atmosphere is pulled from the cavity of the environmental chamber 402 through the breather hole 430 and into the internal compartment 410.

When atmosphere flows past the sensor 416, the sensor 416 detects an atmospheric condition, such as relative humidity in the atmosphere. In one embodiment, in response to detection of the relative humidity, a signal is sent via the signal paths 418 to a test module (not shown) that responds to the signal from the sensor 416. In one embodiment, the test module may record the level of relative humidity sensed by the sensor 416. In an alternative embodiment, the test module responsively initiates an action in the test process, such as, closing the valve 420, or deactivating the pressurization mechanism (e.g., spinning down the discs 108 or turning off a pump) when the detected relative humidity reaches a threshold level.

For example, when the relative humidity detected by the sensor 416 reaches a target relative humidity, the discs 108 may be spun down (deactivated) to stop active transport of atmosphere into the internal compartment 410 of the disc drive 100. As another example, in response to detecting a target relative humidity by the sensor 416, a pump connected to the atmosphere transport connector 412 may be deactivated to stop active transport of atmosphere into the internal compartment 410 of the disc drive 100.

In a particular embodiment, distribution connectors 432 are provided on the transport connector 412. The distribution connectors 432 may be connected to multiple disc drives to allow for simultaneous equilibration of multiple disc drives for environmental testing. In this embodiment, a pressurization mechanism can be connected to a distal end of the connector 412 to facilitate active transport of target atmosphere into internal compartments of disc drives coupled to proximate ends of the distribution connectors 432. Another embodiment may use distribution connectors 432 in combination with a manifold.

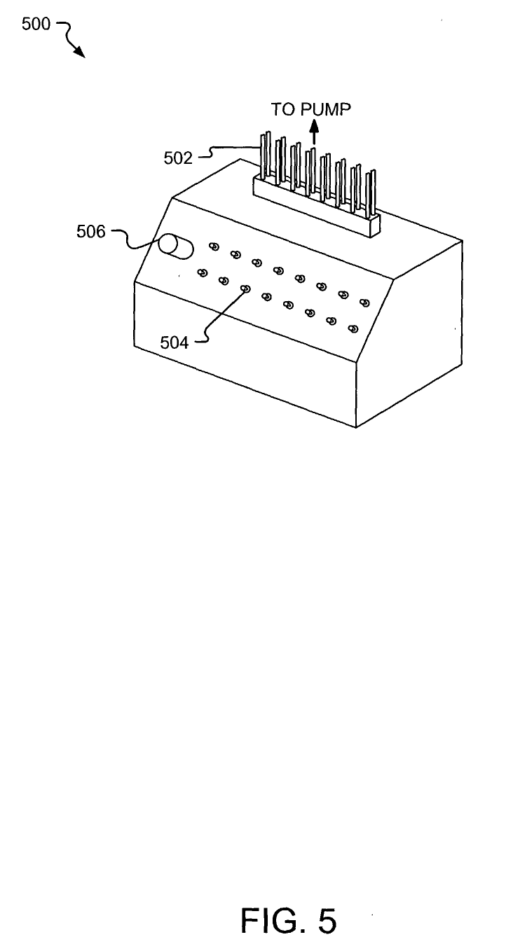

FIG. 5 illustrates a manifold 500 that may be used to connect multiple sealed devices to one or more pumps to facilitate active transport of atmosphere into the devices in accordance with an embodiment of the present invention. In a particular embodiment of the manifold 500, atmosphere pressure created by the pump is distributed among 16 connectors 502 and may allow for active transport of atmosphere into the internal compartments of 16 corresponding sealed devices simultaneously. As illustrated in FIG. 5, the manifold 500 includes 16 switches 504, each switch 504 being associated with one of the atmosphere transport connectors 502. A controller 506 controls atmosphere flow through the atmosphere transport connectors 504. Although the manifold 500 is shown as having 16 connectors corresponding to 16 devices under test, it is to be understood that any number of connectors and devices may be connected through a manifold. The number of connectors in the manifold depends on the particular implementation.

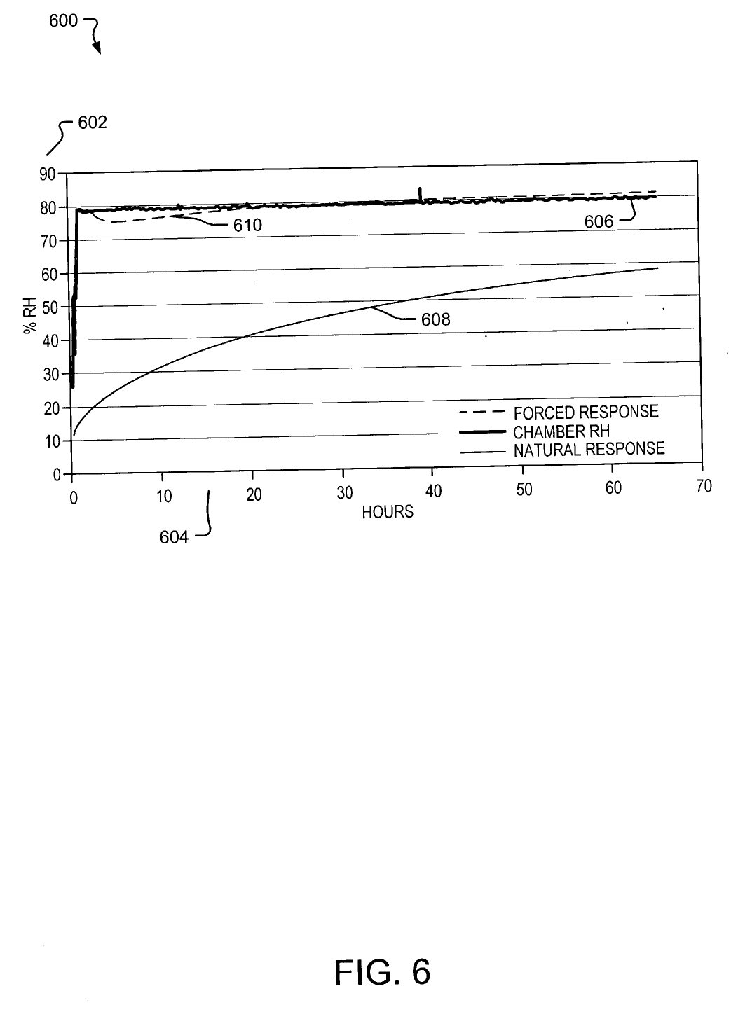

FIG. 6 illustrates a graph 600 having response curves related to responses to changes in relative humidity during environmental testing. The graph 600 includes a range of percent relative humidity values 602 on the vertical axis and a range of time values 604 on the horizontal axis. Thus, the graph 600 illustrates change in percent relative humidity over time.

The graph 600 illustrates results from environmental testing for two environmental tests. In both tests, a disc drive was placed in an environmental chamber, and the environmental chamber was turned on to create a target relative humidity within the environmental chamber. The chamber response curve 606 illustrates the change in percent relative humidity within the environmental chamber over time in an apparatus constructed and operated in accordance with an embodiment of the present invention. When the environmental chamber was switched on, and within about the first hour, the percent relative humidity within the chamber changes from around 25% relative humidity to around 80% relative humidity, which, in this embodiment, is the target relative humidity. The chamber response curve 606 represents the environmental test conditions within the chamber, with which the internal compartment of the a disc drive is to equilibrate.

In one environmental test, a disc drive was placed in the chamber and atmosphere was not actively transported into the internal compartment of the disc drive. During this test, the percent humidity within the internal compartment of the disc drive was monitored as it naturally changed in response to the relative humidity in the chamber. The result of this test is seen in a natural response curve 608. The natural response curve 608 illustrates that at time 0, atmosphere in the internal compartment of the disc drive has a relative humidity of around 12% relative humidity. By diffusion through diffusion paths in the casing of the disc drive, such as the diffusion-limiting breather hole, the percent relative humidity of atmosphere in the internal compartment of the disc drive slowly increases to around 68% relative humidity after around 65 hours. As can be seen in the natural response curve 608, using the natural, or passive, approach toward equilibration, the internal compartment of the disc drive does not reach the target percent relative humidity (i.e., 80%), within 65 hours of waiting.

In a second test, a disc drive was placed in the chamber and atmosphere was actively transported into the internal compartment of the disc drive using methods and systems in accordance with an embodiment of the present invention. As a result of this test, a forced response curve 610 was generated. As illustrated, the forced response curve 610 jumps from around 25% relative humidity to around 80% relative humidity (i.e., the target relative humidity), within around the first hour of testing. After around the first hour of testing, the forced response curve 610 dips slightly to around 75% relative humidity but subsequently increases back to the target relative humidity; i.e., 80% relative humidity.

After reaching 80% relative humidity, the atmosphere in the internal compartment of the disc drive substantially maintains the percent relative humidity as can be seen by the forced response curve 610. Thus, as can be seen by the graph 600, by using active atmosphere transport methods and systems as described herein, equilibration of atmosphere in the internal compartment of a substantially device and atmosphere outside the device occurs substantially more quickly than when these methods and systems are not used.

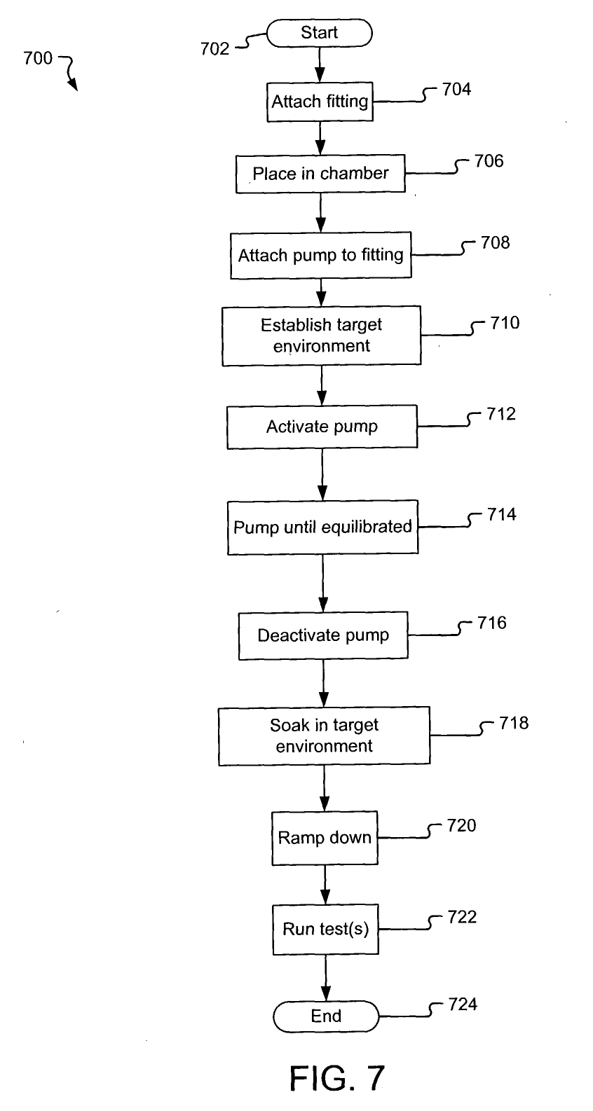

An operation flow 700 is illustrated in FIG. 7 having exemplary operations that may be used in accordance with one embodiment of the present invention. In general, the operations illustrated in operation flow 700 may be used to expose components in an internal compartment of a device under test to target environmental parameters using active atmosphere transport methods. In this particular embodiment, a pump is used to actively transport atmosphere into the internal compartment of a device that is under test; however, it is to be understood that other pressurization mechanisms, other than a pump, may be used to perform the operations described herein. In addition, the operation flow 700 is easily adapted by one skilled in the art to facilitate environmental testing multiple substantially sealed devices simultaneously.

After a start operation 702, a fitting is attached to the device under test in an attach operation 704. In one embodiment, the fitting is a threaded fitting that attaches an atmosphere transport connector to a port in a housing of the device under test. After the fitting is attached, the device under test is placed in an environmental chamber in a place operation 706. In an attach operation 708, a pump is attached to a fitting on a distal end of the atmosphere transport connector. After the pump is attached, an establish operation 710 establishes a target environment in the environmental chamber. The target environment may be established in a conventional environmental chamber that has adjustable settings related to target environmental parameters that may be set by an operator. In one embodiment, the target environment includes a target percent relative humidity. In other embodiments, target atmosphere criteria, in addition to or other than a target percent relative humidity, is established in the established operation 710.

An activate operation 712 activates the pump to begin pumping atmosphere into or out of the internal compartment of the device that is under test. In one embodiment of the activate operation 712, activating the pump includes opening a valve disposed between the pump and the port in the device under test. After the pump is activated in the activate operation 712, a pump operation 714 actively transports atmosphere from the environmental chamber into the internal compartment of the sealed device until the atmosphere in the internal compartment meets the target criteria for the test. The pump operation 712 may involve actively transporting atmosphere by using pressure or suction. Results of tests of disc drives using active atmosphere transport methods described herein show that the pump operation 714 can reach equilibration in around two hours for disc drives. The range of time for equilibration in the pump operation 714 may vary depending on the particular implementation. Tests indicate that by using active atmosphere transport as described herein, the time for equilibration in the pump operation 714 is substantially reduced over prior approaches wherein passive transport methods are used.

After equilibration is established, a deactivate operation 716 deactivates the pump. The deactivate operation 716 may involve turning off the pump and/or closing a valve disposed between the pump and the port on the device under test. In a soak operation 718, the device under test soaks in the target environment. In one embodiment, the device under test soaks in atmosphere that has a target humidity of 80% relative humidity in order to test a corrosive effect of humidity on components within the device under test. The soak operation 718 exposes internal components of the test device to the target environment for a predetermined amount of time. The amount of time that the device is soaked (in the soak operation 718) in the target environment depends on the type of test and the particular implementation.

After the soak operation 718, a ramp down operation 720 ramps the internal compartment of the device under test down to a non-target environment, such as the ambient atmosphere or the environment in the internal compartment prior to equilibration. In one embodiment of the ramp down operation 720, the device under test is taken out of the environmental chamber, thus removing the device under test from the target environment. In this embodiment, the pump is then turned on to pump non-target environment atmosphere into the internal compartment of the device under test. The ramp down operation 720 is optional, and may greatly reduce the overall time for environmental testing.

After the ramp down operation 720, a run operation 722 runs tests on the device under test. The run operation 722 involves executing any relevant tests on the device under test and its internal components to determine how the device and its components respond to the effects of the target environment. Any tests may be run in the run operation 722, and the particular tests that are run are not relevant to embodiments of the present invention. After the tests are run in the run operation 722, an end operation 724 ends the operation flow 700.

In summary, an embodiment of the present invention may be viewed as a method of environmentally testing a substantially sealed device (such as 100) by actively transporting (such as 712, 714) atmosphere from a test environment (such as 304) into an internal compartment (such as 320) of the substantially sealed device (such as 100). Actively transporting atmosphere may involve connecting (such as 704, 708) a proximate end (such as 328) of an atmosphere transport connector (such as 318) to a port (such as 322) in a housing (such as 104, 102) of the device (such as 100) and activating (such as 712) a pressurization mechanism (such as 108, 324) to actively transport atmosphere out of the internal compartment (such as 320) via the atmosphere transport connector (such as 318), and to actively transport the atmosphere from the test environment (such as 304) into the internal compartment (such as 320) of the device (such as 100) via a flow path (such as 316) in the housing (such as 104, 102).

The method may further include placing (such as 706) the device (such as 100) in an environmental chamber (such as 302) having a target atmosphere meeting target criteria, and establishing (such as 710) the test environment (such as 304) in the environmental chamber (such as 302). The method may further include connecting (such as 708) a pump (such as 324) to a distal end (such as 326) of the atmosphere transport connector (such as 318), and activating (such as 712) the pump (such as 324) to pull atmosphere from the internal compartment (such as 320) of the substantially sealed device (such as 100).

Another embodiment may be viewed as an environmental test system (such as 300) for performing environmental tests on a device (such as 100) having a housing (such as 102, 104) forming a substantially sealed internal compartment (such as 320), the housing having at least one void (such as 316) forming a flow path (such as 316) allowing atmosphere to flow there through. The environmental test system (such as 300) includes a port module (such as 408) attached to an opening (such as 322, 406) in the housing (such as 102 and 104). In a particular embodiment, the port module (such as 408) is attached to an atmosphere transport connector (such as 318) transport atmosphere to or from the internal compartment (such as 320), and/or a pressurization mechanism (such as 324 and 108) in fluid communication with the internal compartment (such as 320) of the device (such as 100) and the atmosphere transport connector (such as 318).

One embodiment of the environmental test system (such as 300) includes a pump (such as 324) attached to a distal end (such as 326) of the atmosphere transport connector (such as 318), whereby the pump (such as 324) can pull atmosphere out of the internal compartment (such as 320). In another embodiment, spinning discs (such as 108) in a disc drive (such as 100) serve as the pressurization mechanism. In yet another embodiment, a controlled flow path module (such as 414) is included to create a desired flow rate in the device (such as 100) for simulating diffusion through the housing (such as 102 and 104) of the device (such as 100).

It will be clear that the present invention is well adapted to attain the ends and advantages mentioned as well as those inherent therein. While a presently preferred embodiment has been described for purposes of this disclosure, various changes and modifications may be made which are well within the scope of the present invention. The present invention may be implemented to environmentally test any substantially sealed device. For example, the present invention may be implemented to test avionics equipment, medical equipment, or other equipment that has an internal compartment that is substantially sealed to reduce deterioration from destructive elements. The destructive elements may be humidity or any other airborne elements, such as chemicals. In addition, in order to conduct environmental testing, the device under test need not be place in an environmental chamber; the systems and methods may be practiced anywhere it may be desirable to cause equilibration between atmosphere in an internal compartment of the device and atmosphere outside the device. Numerous other changes may be made which will readily suggest themselves to those skilled in the art and which are encompassed in the spirit of the invention disclosed and as defined in the appended claims.

What is claimed is:

1. A method of environmentally testing a substantially sealed device comprising steps of:
(a) actively transporting atmosphere from a test environment into an internal compartment of the substantially sealed device.

2. The method of claim 1 wherein the substantially sealed device includes a housing forming the internal compartment and the step (a) of actively transporting atmosphere comprises steps of:
(a)(i) connecting a proximate end of an atmosphere transport connector to a port in the housing; and
(a)(ii) activating a pressurization mechanism operable to actively transport atmosphere out of the internal compartment via the atmosphere transport connector, and to actively transport the atmosphere from the test environment into the internal compartment of the substantially sealed device via a flow path in the housing.

3. The method of claim 1 further comprising steps of:
(b) placing the substantially sealed device in an environmental chamber operable to create the test environment having target atmosphere having target criteria; and
(c) establishing the test environment in the environmental chamber.

4. The method of claim 2 wherein the pressurization mechanism is a pump and the activating step (a)(ii) comprises steps of:
(a)(ii)(1) connecting the pump to a distal end of the atmosphere transport connector; and
(a)(ii)(2) activating the pump to pull atmosphere from the internal compartment of the substantially sealed device.

5. The method of claim 2 wherein the device is a disc drive and the pressurization mechanism is a disc in the disc drive and the step (a)(ii) of activating the pressurization mechanism comprises a step of:
(a)(ii)(1) spinning the disc to push atmosphere out of the internal compartment via the atmosphere transport connector.

6. The method of claim 3 wherein the step (a)(ii) of activating the pressurization mechanism comprises steps of:
(a)(ii)(1) pulling the target atmosphere from the environmental chamber into the internal compartment of the substantially sealed device.

7. The method of claim 3 wherein the step (a)(ii) of activating the pressurization mechanism comprises steps of:
(a)(ii)(2) pushing the target atmosphere into the internal compartment of the substantially sealed device.

8. The method of claim 3 further comprising steps of:
(d) soaking the internal compartment of the substantially sealed device in the target atmosphere.

9. The method of claim 3 wherein the target atmosphere comprises a target relative humidity.

10. The method of claim 3 wherein the device is a disc drive and the flow path in the housing is a breather hole.

11. The method of claim 10 wherein a filter is disposed within the breather hole.

12. The method of claim 11 wherein an absorbent material is disposed within the breather hole.

13. The method of claim 8 further comprising steps of:
(e) automatically deactivating the pressurization mechanism in response to detecting atmosphere in the internal compartment having the target criteria.

14. The method of claim 13 wherein the step (e) of automatically deactivating the pressurization mechanism comprises steps of:
(e)(i) closing a valve disposed in a path of the atmosphere transport connector to thereby block atmosphere flow from the internal compartment.

15. The method of claim 13 further comprising steps of:
(f) ramping down the atmosphere in the internal compartment such that the atmosphere in the internal compartment has non-target criteria.

16. The method of claim 15 further comprising steps of:
(g) creating a controlled flow path in the internal compartment.

17. The method of claim 1 further comprising steps of:
(b) actively replacing the transported atmosphere with characteristic atmosphere, wherein the characteristic atmosphere meets predetermined criteria comprising one or more of a target relative humidity, a target temperature, a target aerosol composition, and a target density.

18. An environmental test system for performing environmental tests on a device having a housing forming a substantially sealed internal compartment, the housing having at least one void forming a flow path allowing atmosphere to flow there through, the environmental test system comprising:
a port module attached to an opening in the housing;
an atmosphere transport connector attached to the port module operable to transport atmosphere to or from the internal compartment; and
a pressurization mechanism in fluid communication with the internal compartment of the device and the atmosphere transport connector.

19. The environmental test system of claim 18 wherein the pressurization mechanism comprises:
a pump attached to a distal end of the atmosphere transport connector operable to pull atmosphere out of the internal compartment.

20. The environmental test system of claim 18 wherein the device is a disc drive and the pressurization mechanism comprises:
one or more spinning discs within the housing of the disc drive.

21. The environmental test system of claim 18 further comprising:
a controlled flow path module operable to create a desired flow rate in the device for simulating diffusion through the housing of the device.

22. The environmental test system of claim 18 further comprising:
a sensor operable to detect a parameter in the atmosphere of the internal compartment.

23. The environmental test system of claim 18 further comprising:
a valve disposed in a path of fluid communication through the atmosphere transport connector, operable to stop or start fluid communication through the atmosphere transport connector.

24. The environmental test system of claim 18 further comprising:
a manifold connected to a plurality of substantially sealed devices for engaging fluid communication between the devices and one or more pressurization mechanisms.

25. The environmental test system of claim 24 wherein the manifold comprises:
a plurality of switches, each switch associated with one of the plurality of devices and operable to engage and disengage fluid communication between the associated device and the one or more pressurization mechanisms.

26. An environmental test system for environmentally testing a substantially sealed device comprising:
a test environment having target atmosphere comprising target criteria; and
means for actively transporting the target atmosphere into an internal compartment of the substantially sealed device.

27. The environmental test system of claim 26 wherein the means for actively transporting the target atmosphere comprises:
a pump in fluid communication with the internal compartment.

28. The environmental test system of claim 26 wherein the substantially sealed device is a disc drive and the means for actively transporting the target atmosphere comprises:
a spinning disc within the disc drive in fluid communication with the test environment.

29. The environmental test system of claim 26 further comprising:
a sensor operable to detect a parameter in atmosphere in the internal compartment of the device and responsively generate a signal representing the parameter; and
a signal path carrying the signal to a switch operable to change positions in response to the signal meeting a predetermined threshold value to thereby discontinue active transport of atmosphere.

30. The environmental test system of claim 29 wherein the switch is in operable communication with a valve in a path of the target atmosphere, the switch operable to open and close the valve.
